(19) United States
(12) Patent Application Publication
(10) Pub. No.: US 2026/0000060 A1
(43) Pub. Date: Jan. 1, 2026

(54) FISHING LINE GUIDE AND FISHING ROD

(71) Applicant: GLOBERIDE, Inc., Higashikurume-shi, Tokyo (JP)

(72) Inventors: Kazuki KAWAI, Higashikurume-shi (JP); Toshiki MORIOKA, Higashikurume-shi (JP)

(73) Assignee: GLOBERIDE, Inc., Higashikurume-shi, Tokyo (JP)

(21) Appl. No.: 18/880,777

(22) PCT Filed: Jul. 11, 2023
(86) PCT No.: PCT/JP2023/025517

§ 371 Date: Jan. 2, 2025

(30) Foreign Application Priority Data
Oct. 27, 2022 (JP) 2022-171869

(51) Int. Cl. A01K 87/04; A01K 87/02

(52) U.S. Cl. CPC A01K 87/04; A01K 87/025

(57) ABSTRACT

A fishing line guide including a guide main body that comprise a ring holding portion to which an annular guide ring is attached; a first leg portion that extends from the guide main body; a second leg portion that branches from the guide main body and extends at an angle different from an angle in an extending direction of the first leg portion; and a fixing portion that is formed between and connected to the first leg portion and the second leg portion and is used to fix the fishing line guide to a rod body of a fishing rod. A through-hole is formed between the first leg portion, the second leg portion, and the fixing portion.

### TECHNICAL FIELD

### Cross Reference

The present application claims priority based on Japanese Patent Application No. 2022-171869 (filed on Oct. 27, 2022), the contents of which are incorporated herein by reference in their entirety.

The present invention relates to a fishing line guide for guiding a fishing line fixed to a rod body outer surface of a fishing rod, and a fishing rod comprising the same.

### Background Art

Conventionally, as a fishing line guide for guiding a fishing line to a fishing rod, various fishing line guides in which a guide ring is fitted into a through-hole of the fishing line guide are known.

As such a fishing rod guide, for example, Patent Literature 1 discloses a leg portion structure of a line guiding ring for the fishing rod in which a large number of spike-like locking projections having a diameter smaller than a diameter of a fixing line are formed on a top surface of a rod attachment leg of the line guiding ring.

In addition, Patent Literature 2 discloses a monopodal fishing line guide in which one of shapes of a support leg to which a guide ring attachment fitting is attached is formed in a triangular shape, and welding is performed at an arbitrary height to a portion where the support leg is opened to attach a guide ring.

### CITATION LIST

### Patent Literature

Patent Literature 1: JP 54-029273 U

Patent Literature 2: JP 2002-171872 A

### SUMMARY OF INVENTION

### Technical Problem

However, even in the fishing rod guide disclosed in any of Patent Literatures, there is a problem that when a load is applied to the guide, the fishing rod guide falls off from a fixing position of the surface of the fishing rod or is damaged by concentrated stress. In addition, in order to prevent such falling off, the guide leg can be lengthened, but there is also a problem that the weight increases due to this. On the other hand, when the guide leg is shortened in order to reduce the inhibition of bending of the rod, there is also a problem that the fixing force tends to be insufficient.

The present invention has been made in view of the above circumstances, and an object thereof is to provide a fishing line guide that is lightweight, does not inhibit bending of a rod body, and can be held by the rod body with a sufficient fixing force without falling off from a fixing position on a surface of the rod body even when a load is applied to the guide, and a fishing rod comprising the same. Other objects of the present invention will become apparent upon reference to the entirety of the present specification.

### Solution to Problem

A fishing line guide according to one embodiment of the present invention is a fishing line guide comprising: a guide main body that comprise a ring holding portion to which an annular guide ring is attached; a first leg portion that extends from the guide main body; a second leg portion that branches from the guide main body and extends at an angle different from an angle in an extending direction of the first leg portion; and a fixing portion that is formed between and connected to the first leg portion and the second leg portion and is used to fix the fishing line guide to a rod body of a fishing rod. A through-hole is formed between the first leg portion, the second leg portion, and the fixing portion.

In the fishing line guide according to one embodiment of the present invention, the through-hole is configured to have a triangular shape when the through-hole is viewed in a direction parallel to the guide main body.

In the fishing line guide according to one embodiment of the present invention, an angle in the extending direction of the first leg portion and an angle in the extending direction of the second leg portion are different in a range of 5 degrees to 45 degrees.

In the fishing line guide according to one embodiment of the present invention, a thickness of the ring holding portion is in a range of 1.5 mm to 2.5 mm.

In the fishing line guide according to one embodiment of the present invention, a thickness of the first leg portion is in a range of 0.5 mm to 1.2 mm.

In the fishing line guide according to one embodiment of the present invention, a thickness of the second leg portion is in a range of 0.5 mm to 1.2 mm.

In the fishing line guide according to one embodiment of the present invention, a thickness of the fixing portion is in a range of 0.2 mm to 1.0 mm.

In the fishing line guide according to one embodiment of the present invention, a thickness of the ring holding portion is equal to or larger than a thickness of the first leg portion or the second leg portion, and a thickness of the fixing portion is equal to or smaller than the thickness of the first leg portion or the second leg portion.

In the fishing line guide according to one embodiment of the present invention, the fixing portion is attached to an outer surface of the rod body by line winding, line fastening, or sheet winding.

In the fishing line guide according to one embodiment of the present invention, a part of the second leg portion is attachable/detachable or openable/closable.

In the fishing line guide according to one embodiment of the present invention, a plurality of recessed portions are formed on a second surface of the fixing portion on a side opposite to a first surface on a side on which the rod body is arranged in a use state of the fishing line guide, along a longitudinal direction of the second surface.

In the fishing line guide according to one embodiment of the present invention, the fixing portion is provided with a protruding portion that extends from the fixing portion and protrudes outward beyond the second leg portion or the first leg portion.

In the fishing line guide according to one embodiment of the present invention, the protruding portion is attached to an outer surface of the rod body by line winding, line fastening, or sheet winding.

A fishing rod according to one embodiment of the present invention comprises the fishing line guide according to any one of the above descriptions; and a rod body.

### Advantageous Effects of Invention

According to the above embodiment, it is possible to provide a fishing line guide that is lightweight, does not inhibit bending of a rod body, and can be held by the rod body with a sufficient fixing force without falling off from a fixing position on a surface of the rod body even when a load is applied to the guide, and a fishing rod comprising the same.

### BRIEF DESCRIPTION OF DRAWINGS

FIG. 1 is a view illustrating a fishing rod according to an embodiment of the present invention.

FIG. 2(a) is a front view of a fishing line guide 10 in an embodiment of the present invention, FIG. 2(b) is a side view of the fishing line guide 10 in the embodiment of the present invention, and FIG. 2(c) is a perspective view of the fishing line guide 10 in the embodiment of the present invention.

FIG. 3 is a view for explaining a method of fixing a fixing portion in the fishing line guide according to the embodiment of the present invention to a rod body.

FIG. 4 is a view for explaining a second leg portion 13 in the fishing line guide 10 according to the embodiment of the present invention.

FIG. 5 is a view for explaining an end surface of a fixing portion 1 in the fishing line guide according to the embodiment of the present invention.

FIG. 6 is a view for explaining a protruding portion in the fishing line guide according to the embodiment of the present invention.

FIG. 7 is a view for explaining a method of fixing the protruding portion in the fishing line guide according to the embodiment of the present invention to the rod body.

FIG. 8 is a side view of a fishing line guide according to another embodiment of the present invention.

### DESCRIPTION OF EMBODIMENTS

Hereinafter, an embodiment of a fishing rod according to the present invention will be specifically described with reference to the accompanying drawings. Components common in a plurality of drawings are assigned with the same reference signs throughout the plurality of drawings. It should be noted that each of the drawings is not always illustrated in a precise aspect ratio for the convenience of description.

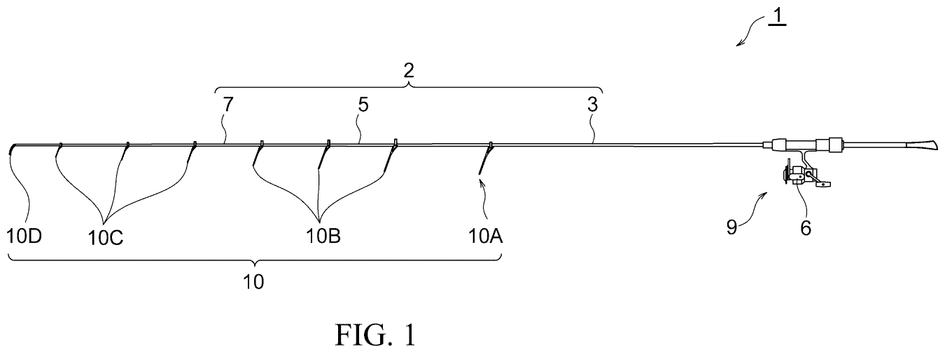

FIG. 1 is a view illustrating an embodiment of a fishing rod according to the present invention. As illustrated in the drawing, a fishing rod 1 according to an embodiment of the present invention comprises a rod body 2, a reel 6 attached to the rod body 2 via a fishing line guide 9 (also referred to as a reel seat, but referred to as a fishing line guide in the present specification) to be described later, and a fishing line guide 10 attached to the rod body 2. In the illustrated embodiment, each of the fishing line guide 9 and the fishing line guide 10 corresponds to an attachment component attached to an outer peripheral surface of the rod body.

The rod body 2 is formed by, for example, connecting a base rod 3, a middle rod 5, a tip rod 7, and the like to each other. These rod bodies are jointed to each other, for example, as an ordinarily jointed type. The base rod 3, the middle rod 5, and the tip rod 7 can be jointed to each other as a telescopic type, an inversely jointed type, a socket-and-spigot jointed type, or any other known jointed type. The rod body 2 may be formed by a single rod body.

Each of the base rod 3, the middle rod 5, and the tip rod 7 is formed by, for example, a tubular body made of a fiber-reinforced resin. This tubular body made of the fiber-reinforced resin is produced by winding a fiber-reinforced resin prepreg (prepreg sheet) obtained by impregnating reinforcing fibers with a matrix resin around a core metal, and heating and curing the prepreg sheet. As the reinforcing fibers contained in the prepreg sheet, for example, carbon fibers, glass fibers, and any other known reinforcing fibers can be used. As the matrix resin contained in the prepreg sheet, a thermosetting resin such as an epoxy resin can be used. After the prepreg sheet is cured, the core metal is removed. An outer surface of the tubular body is appropriately polished. Each of the rod bodies may be provided in a solid state.

In the illustrated embodiment, the base rod 3, the middle rod 5, and the tip rod 7 are provided with a plurality of fishing line guides 10 (fishing line guides 10A to 10D) for guiding a fishing line fed from the reel 6. More specifically, the base rod 3 is provided with the fishing line guide 10A, the middle rod 5 is provided with the fishing line guide 10B, and the tip rod 7 is provided with the fishing line guide 10C. The top guide 10D is provided at the tip of the tip rod 7. Details of the fishing line guide 10 will be described later.

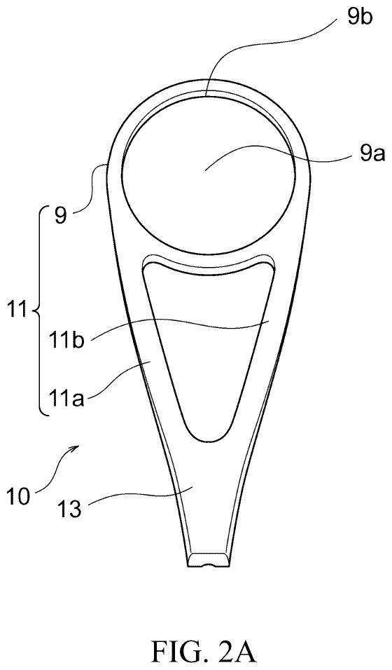

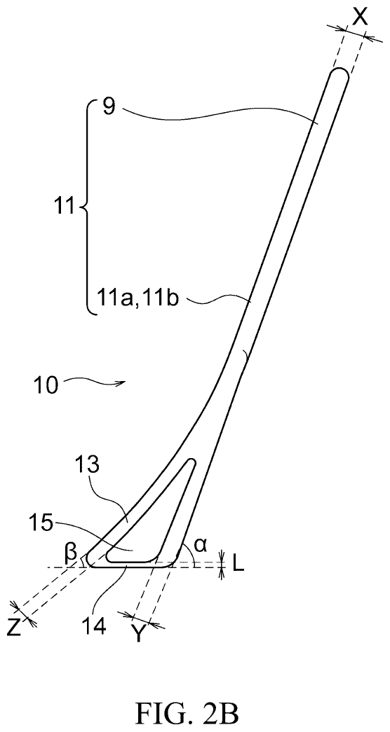

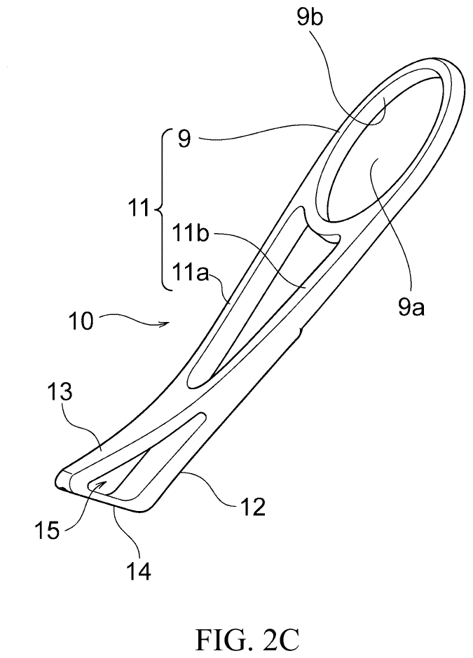

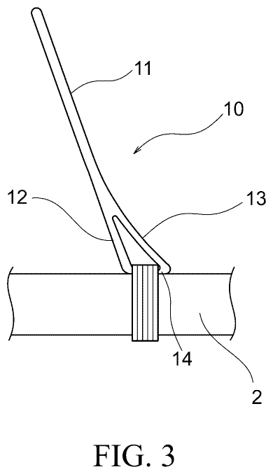

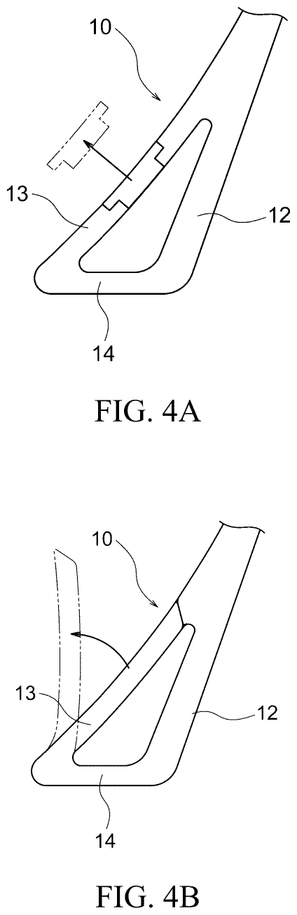

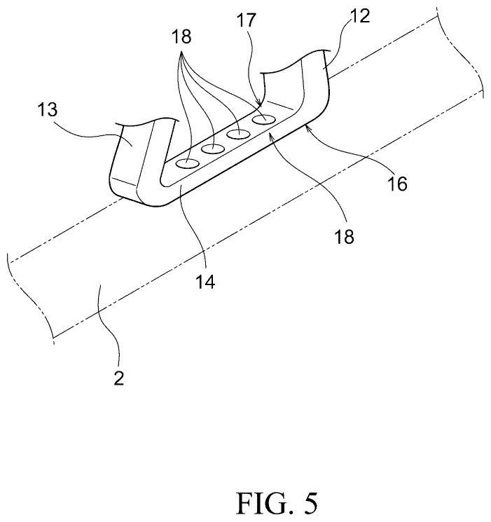

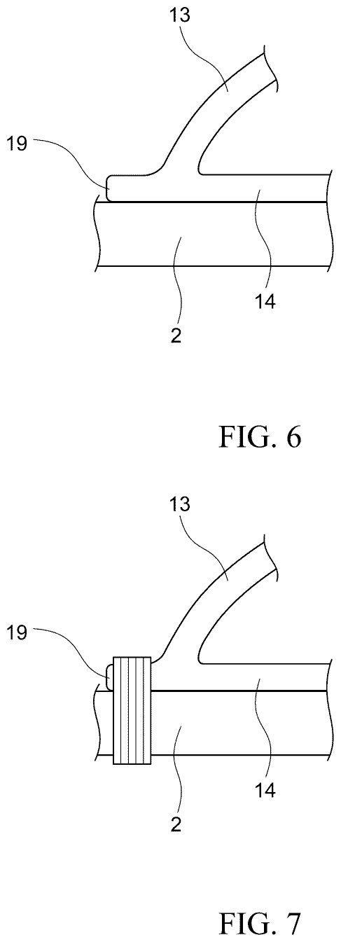

A fishing line guide according to an embodiment of the present invention will be described with reference to FIGS. 2 to 7. FIG. 2(a) is a front view of the fishing line guide 10 in the embodiment, FIG. 2(b) is a side view of the fishing line guide 10 in the embodiment, and FIG. 2(c) is a perspective view of the fishing line guide 10 in the embodiment. FIG. 3 is a view for explaining a method of attaching a fixing portion of the fishing line guide according to the embodiment of the present invention to the rod body, and FIG. 4 is a view for explaining a second leg portion 13 in the fishing line guide 10 according to the embodiment of the present invention. FIG. 5 is a view for explaining an end surface of a fixing portion 1 in the fishing line guide according to the embodiment of the present invention. FIG. 6 is a view for explaining a protruding portion in the fishing line guide according to the embodiment of the present invention, and FIG. 7 is a view for explaining a method of fixing the protruding portion in the fishing line guide according to the embodiment of the present invention to the rod body.

As illustrated in FIG. 2, the fishing line guide 10 according to the embodiment of the present invention is the fishing line guide 10 comprising: a guide main body 11 having a ring holding portion 9 to which an annular guide ring (not illustrated) is attached; a first leg portion 12 extending from the guide main body 11; a second leg portion 13 branching from the guide main body 11 and extending at an angle (angle β in FIG. 2(b)) different from an angle (angle α in FIG. 2(b)) in an extending direction of the first leg portion 12; and a fixing portion 14 formed between and connected to the first leg portion 12 and the second leg portion 13 and used to fix the fishing line guide to the rod body 2 of the fishing rod 1. A through-hole (space or gap) 15 is formed between the first leg portion 12, the second leg portion 13, and the fixing portion 14. Here, as illustrated in FIG. 2, the angle α refers to an angle of the first leg portion 12 at an end position of the first leg portion 12, and the angle β refers to an angle of the second leg portion 13 at an end position of the second leg portion 13. Further, in the illustrated example, since the second leg portion 13 has the same angle (α) as the first leg portion 12 at the position branching from the guide main body 11 and the second leg portion 13 is curved in the extending direction, the angle gradually approaches the angle (β) and finally becomes an angle of the angle (β). However, the present invention is not limited to the illustrated example, and various modes are conceivable.

According to the fishing line guide 10 of the embodiment of the present invention, it is possible to provide a fishing line guide that is lightweight, does not inhibit bending of the rod body, and can be held by the rod body with a sufficient fixing force without falling off from a fixing position on a surface of the rod body even when a load is applied to the guide.

As a material of the fishing line guide 10, a metal, a resin, or a fiber-reinforced resin can be usually used, but the present invention is not limited thereto. In addition, the metal is usually considered as a material of the guide ring, but ceramics (SiC or the like) or other materials may be used. Here, as illustrated in FIGS. 1 and 2(b), the fishing line guide 10 is inclined upward from the rear side of the rod body 2 (the hand side of the fishing rod) toward the front side (the tip side of the fishing rod) in an attached state. That is, at the time of being attached to the rod body 2, the fishing line guide 10 takes a posture tilted to the front side of the rod body 2 (in a tip direction of the fishing rod 1). Note that a front-rear direction refers to a front-rear direction (extending direction of the fishing rod 1) illustrated in FIG. 1. The front direction is a direction from the hand end toward the tip along the rod axis of the fishing rod 1. In addition, an up-down direction refers to a direction perpendicular to the front-rear direction, and an upper side with respect to a front-rear direction line is defined as an upper direction and a lower side is defined as a lower direction.

The ring holding portion 9 has a through-hole 9a, and the through-hole 9a penetrates the ring holding portion 9 along the guide central axis. The through-hole 9a is defined by an inner peripheral surface 9b of the ring holding portion 9, and has, for example, a shape that is bilaterally symmetrical and vertically symmetrical in front view. The guide central axis passes through the center of the through-hole 9a and extends in the front-rear direction.

Next, an annular guide ring (not illustrated) is press-fitted into the through-hole 9a of the ring holding portion 9. The guide central axis passes through the center of the guide ring. The guide ring is formed of, for example, a ceramic, a metal, an alloy, or a composite material thereof. The guide ring may comprise a base material layer, an inner surface layer formed on a surface on an inner peripheral surface side of the base material layer, and an outer surface layer formed on a surface on an outer peripheral surface side of the base material layer. The base material layer is made of, for example, an alloy containing Co, Ni, Cr, Mo, Fe, and inevitable impurities. The base material layer may contain Mn, Ti, and/or Nb. The inner surface layer and the outer surface layer are made of, for example, chromium carbide (CrC), titanium carbide (TiC), or vanadium carbide (VC). The inner surface layer and the outer surface layer can have a high Vickers hardness of about 1300 Hv to 3000 Hv. Further details are omitted.

As illustrated in FIG. 2, the guide main body 11 comprises a first connection portion 11a and a second connection portion 11b, these connection portions connect the ring holding portion 9 described above to the first leg portion 12 and the second leg portion 13 described later, and a space is formed between the bottom portion of the ring holding portion 9 and the first connection portion 11a and the second connection portion 11b. In this way, it is possible to reduce the weight of these connection portions.

As illustrated in FIG. 2, in the fishing line guide 10 according to the embodiment of the present invention, the through-hole 15 is configured to have a triangular shape when viewed in a direction parallel to a width direction (left-right direction in FIG. 2(a)) of the guide main body 11 (when viewed in a direction of a side surface in FIG. 2(b)). In this way, a truss structure can be formed, a lightweight and highly rigid guide can be formed, and the guide removal can be effectively prevented by closing the fixing portion. Here, as described above, since the second leg portion 13 is curved, the through-hole 15 does not have a triangular shape in a strict sense, but can be referred to as a substantially triangular shape, and in the present specification, the substantially triangular shape is also included.

In the fishing line guide 10 according to the embodiment of the present invention, the angle (α) in the extending direction of the first leg portion 12 and the angle in the extending direction of the second leg portion 13 are different in a range of 5 degrees to 45 degrees. In this way, it is possible to form a guide that is lighter and more rigid.

In the fishing line guide 10 according to the embodiment of the present invention, a thickness (X) of the ring holding portion 9 illustrated in FIG. 2(b) is in a range of 1.5 mm to 2.5 mm. In this way, it is possible to prevent a direct impact from being applied to the guide ring.

In the fishing line guide 10 according to the embodiment of the present invention, a thickness (Y) of the first leg portion 12 illustrated in FIG. 2(b) is in a range of 0.5 mm to 1.2 mm. In this way, it is possible to reduce the weight while maintaining the required rigidity and strength. In addition, in the fishing line guide 10 according to the embodiment of the present invention, a thickness (Z) of the second leg portion 13 illustrated in FIG. 2(b) is in a range of 0.5 mm to 1.2 mm. In this way, it is possible to reduce the weight while maintaining the required rigidity and strength.

In addition, in the fishing line guide 10 according to the embodiment of the present invention, a thickness (L) of the fixing portion 14 illustrated in FIG. 2(b) is in a range of 0.2 mm to 1.0 mm. In this way, it is possible to reduce the weight while maintaining the required strength. Further, depending on the ring size, a length of the fixing portion 14 can be set to a length in a range of 3 mm to 15 mm. In this way, since the fishing line guide can be formed shorter than the conventional fishing line guide, there is a technical feature that the bending of the rod body is hardly inhibited. Furthermore, since there is no inclination in a line winding region of the fixing portion 14, the line is hardly displaced even with a smaller line winding length, and the fixing force can be stabilized. In the fixing portion 14, the width of the fixing portion 14 (the width in the short direction of the fixing portion 14 (the length viewed in the circumferential direction of the rod body at the time of attachment)) may be reduced at one or a plurality of positions, that is, the fixing portion 14 may have a recessed portion formed at one or a plurality of positions. In this way, the line winding is performed by hooking the line to the recessed portion, so that the fixing force of the fishing line guide can be further improved.

In the fishing line guide 10 according to the embodiment of the present invention, the thickness (X) of the ring holding portion 9 is equal to or larger than the thickness (Y) of the first leg portion 12 or the thickness (Z) of the second leg portion 13, and the thickness (L) of the fixing portion 14 is equal to or smaller than the thickness (Y) of the first leg portion 12 or the thickness (Z) of the second leg portion 13. In this way, it is possible to reduce the weight while maintaining the required strength.

Next, as illustrated in FIG. 3, in the fishing line guide 10 according to the embodiment of the present invention, the fixing portion 14 is attached to the outer surface of the rod body by line winding (example of FIG. 3), line fastening, or sheet winding. In this way, the fixing force of the fishing line guide can be improved.

Next, as illustrated in FIG. 4, in the fishing line guide 10 according to the embodiment of the present invention, a part of the second leg portion 13 is attachable/detachable (in a case of FIG. 4(a)) or openable/closable (in a case of FIG. 4(b)). In this way, the line and the sheet for the line winding, the line fastening, and the sheet winding can be easily and reliably inserted into the through-hole 15, so that the fixing portion 14 of the fishing line guide 10 can be easily fixed to the rod body 2.

Next, as illustrated in FIG. 5, in the fishing line guide 10 according to the embodiment of the present invention, one or a plurality of recessed portions (groove portions) 18 (in the illustrated example, the plurality of recessed portions (groove portions) are formed on a second surface (end surface) 17 of the fixing portion 14 on a side opposite to a first surface (end surface) 16 on a side on which the rod body 2 is arranged in a use state of the fishing line guide 10, along a longitudinal direction P of the second surface 17. In this way, the fixing force of the fishing line guide can be improved. Here, in a case of providing the plurality of recessed portions 18, an interval between the recessed portions 18 adjacent to each other can be set to, for example, 1 mm or more, and a maximum depth of each recessed portion 18 can be set to, for example, 0.3 mm, but the present invention is not limited thereto.

Next, as illustrated in FIG. 6, in the fishing line guide 10 according to the embodiment of the present invention, the fixing portion 14 is provided with a protruding portion 19 that extends from the fixing portion 14 and protrudes outward (leftward (in the case of FIG. 6) or rightward on the paper surface of FIG. 6) beyond the second leg portion 13 (in the case of FIG. 6) or the first leg portion 12. In this way, a line stopping resin is less likely to be peeled off, and whitening can be less likely to be seen even in a case of being peeled and whitened.

Next, as illustrated in FIG. 7, in the fishing line guide 10 according to the embodiment of the present invention, the protruding portion 19 is attached to the outer surface of the rod body 2 by line winding (in the case of FIG. 7), line fastening, or sheet winding. In this way, a line stopping line absorbs the resin, so that the line stopping resin is less likely to be peeled off, and whitening can be less likely to be seen even in a case of being peeled and whitened.

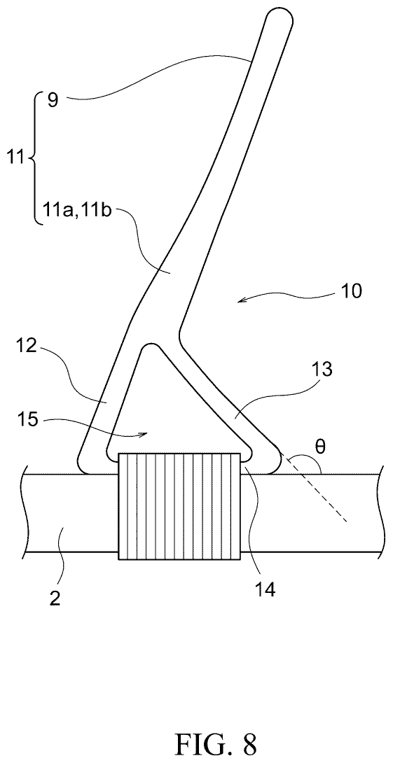

Next, as illustrated in FIG. 8, in a fishing line guide 10 according to another embodiment of the present invention, the second leg portion 13 may be formed on the side opposite to the side on which the second leg portion 13 illustrated in FIG. 2 is provided with reference to the first leg portion 12. In this case, the angle (θ) of the second leg portion 13 illustrated in FIG. 8 is in a range of 90 degrees to 150 degrees. In this way, in a current both-leg guide, two fixing positions can be reduced to one fixing position, and a working time can be shortened. Since other configurations are the same as those described above, further details are omitted.

Next, as illustrated in FIGS. 1 and 2 (or FIG. 8), the fishing rod 1 according to the embodiment of the present invention is configured to comprise any one of the above fishing line guides 10 and the rod body 2.

According to the fishing rod of one embodiment of the present invention, it is possible to provide a fishing rod comprising a fishing line guide that is lightweight, does not inhibit bending of the rod body, and can be held by the rod body with a sufficient fixing force without falling off from a fixing position on a surface of the rod body even when a load is applied to the guide.

Dimensions, a material, and disposition of each component described in the present specification are not limited to dimensions, a material, and disposition that have been explicitly described in the embodiments, and variations can be made to these respective components in such a way that these respective components have arbitrary dimensions, material, and disposition that can be included in the scope of the present invention. Components not explicitly described in the present specification can also be added to the described embodiments, or some of the components described in the embodiments can be omitted.

### Reference Signs List

1 Fishing rod
2 Rod body
3 Base rod
5 Middle rod
6 Reel
7 Tip rod
9 Ring holding portion
9a Through-hole
9b Inner peripheral surface
10 Fishing line guide
11 Guide main body
11a First connection portion
11b Second connection portion
12 First leg portion
13 Second leg portion
14 Fixing portion
15 Through-hole (space or gap)
16 First surface (end surface)
17 Second surface (end surface)
18 Recessed portion (groove portion)
19 Protruding portion

1. A fishing line guide comprising:
a guide main body that comprises a ring holding portion to which an annular guide ring is attached;
a first leg portion that extends from the guide main body;
a second leg portion that branches from the guide main body and extends at an angle different from an angle in an extending direction of the first leg portion; and
a fixing portion that is formed between and connected to the first leg portion and the second leg portion and is used to fix the fishing line guide to a rod body of a fishing rod, wherein
a through-hole is formed between the first leg portion, the second leg portion, and the fixing portion.

2. The fishing line guide according to claim 1, wherein
the through-hole has a triangular shape when the through-hole is viewed in a direction parallel to the guide main body.

3. The fishing line guide according to claim 1, wherein
an angle in the extending direction of the first leg portion and an angle in the extending direction of the second leg portion are different in a range of 5 degrees to 45 degrees.

4. The fishing line guide according to claim 1, wherein
a thickness of the ring holding portion is in a range of 1.5 mm to 2.5 mm.

5. The fishing line guide according to claim 1, wherein
a thickness of the first leg portion is in a range of 0.5 mm to 1.2 mm.

6. The fishing line guide according to claim 1, wherein
a thickness of the second leg portion is in a range of 0.5 mm to 1.2 mm.

7. The fishing line guide according to claim 1, wherein
a thickness of the fixing portion is in a range of 0.2 mm to 1.0 mm.

8. The fishing line guide according to claim 1, wherein
a thickness of the ring holding portion is equal to or larger than a thickness of the first leg portion or the second leg portion, and a thickness of the fixing portion is equal to or smaller than the thickness of the first leg portion or the second leg portion.

9. The fishing line guide according to claim 1, wherein
the fixing portion is attached to an outer surface of the rod body by line winding, line fastening, or sheet winding.

10. The fishing line guide according to claim 1, wherein
a part of the second leg portion is attachable/detachable or openable/closable.

11. The fishing line guide according to claim 1, wherein
a plurality of recessed portions are formed on a second surface of the fixing portion on a side opposite to a first surface on a side on which the rod body is arranged in a use state of the fishing line guide, along a longitudinal direction of the second surface.

12. The fishing line guide according to claim 1, wherein
the fixing portion is provided with a protruding portion that extends from the fixing portion and protrudes outward beyond the second leg portion or the first leg portion.

13. The fishing line guide according to claim 12, wherein
the protruding portion is attached to an outer surface of the rod body by line winding, line fastening, or sheet winding.

14. A fishing rod comprising:
the fishing line guide according to claim 1; and
a rod body.
